(19) United States
(12) Patent Application Publication
(10) Pub. No.: US 2024/0087626 A1
(43) Pub. Date: Mar. 14, 2024

(54) System and Method for Generation of Unique Digital Signature Using a Non-Volatile Memory Array

(71) Applicant: Infineon Technologies LLC, San Jose, CA (US)

(72) Inventors: Amichai GIVANT, Rosh-Ha'ain (IL); Yoav YOGEV, Mazkeret-Batya (IL); Eduardo MAYAAN, Netanya (IL); Yair SOFER, TEL-AVIV (IL)

(73) Assignee: Infineon Technologies LLC, San Jose, CA (US)

(21) Appl. No.: 18/085,972

(22) Filed: Dec. 21, 2022

Related U.S. Application Data
(60) Provisional application No. 63/349,778, filed on Jun. 7, 2022.

(51) Int. Cl. G11C 7/24; G11C 7/10; G11C 7/14

(52) U.S. Cl. CPC G11C 7/24; G11C 7/1069; G11C 7/14

(57) ABSTRACT

A system and method are provided for generating Unique Digital Signatures (UDS) for semiconductor memories to improve data security. Generally, the method involves allocating a number of native memory cells in a memory device; obtaining a multibit binary entropy string (BES) using variations of threshold voltages (V_{T}) of the allocated cells as an entropy source; and mathematically manipulating the BES to generate the UDS. Optionally, the BES can be concatenated with another multibit binary number from a second entropy source internal or external to the memory device, and the result of the concatenation mathematically manipulated to generate the UDS. In one embodiment, a reference voltage is located at a median V_{T} for the cells, and the BES is obtained by reading the cells versus the reference, assigning those having a V_{T} above the reference a first bit value, and the remaining cells a second bit value.

### CROSS-REFERENCE TO RELATED APPLICATIONS

This application is claims the benefit of priority under 35 U.S.C. 119(e) to U.S. Provisional Patent Application Ser. No. 63/349,778, filed Jun. 7, 2022, which is incorporated by reference herein in its entirety.

### TECHNICAL FIELD

This present disclosure relates generally to computer memories, and more particularly to systems and methods for providing Unique Digital Signatures to non-volatile memories for improved data security.

### BACKGROUND

Many modern mechanical and electronic systems and devices include an embedded computer system or embedded system to control operation of the system or device it is embedded within. An embedded system typically includes a computer processor, a number of semiconductor memories, and a number of input/output interfaces to connect to peripheral devices in the larger mechanical or electronic system. Systems and devices including such embedded systems include cars, smart factories, hospital equipment, and portable medical products. As more systems and devices including embedded systems become internet or network connected and autonomous, the possibility of bad actors taking control of these systems and devices is of increasing concern.

One of the primary targets of hackers is the semiconductor memories, and in particular flash or other nonvolatile memory devices (NVM), which is used to store boot code, security keys, passwords and other critical data and log data that are used to keep the embedded system functioning properly. Especially vulnerable are the latest generation of embedded systems in which a need for larger or high performance memory has led to the NVM being implemented externally in a discrete, integrated circuit (IC) or device separate from the computer processor and other elements of the embedded system, which are typically implemented as a host system on another IC or System on a Chip (SoC), and coupled to the NVM through a wired or wireless data bus.

There are many ways in which external NVM can be compromised including: snooping attacks during transactions to and from the NVM to extract unprotected system keys or passwords; stealing Security Keys during provisioning operations in an unsecure processing or fabrication facility when storage assets and keys are being programmed into the embedded system; cloning in which hackers clone the NVM or other elements of the embedded system to compromise the integrity of the embedded system; and side-channel attacks to disclose contents of the NVM through interruptions of power or glitches.

Past approaches to secure embedded systems have focused on supplying a unique identifier that is used to generate secret keys shared between the NVM and host system. These have not been wholly satisfactory for a number of reasons. For example, the unique identifier is typically generated using an external entropy source or random number generator and programmed into the NVM at a fabrication facility for the embedded system. Either the external entropy source or fabrication facility may or may not be secure. Likewise it is possible for the NVM to be hacked, cloned or otherwise compromised between the fabrication facility and a manufacturer of the system or device in which it is embedded.

Accordingly, there is a need for system and method for providing a unique identifier to semiconductor memories generated using an entropy source internal to the memory device to enable an end user or manufacturer of the system or device in which it is embedded to generate the unique identifier at their premises. It is further desirable that the entropy source used to generate the unique identifier is physically unclonable and reflects a ‘fingerprint’ or ‘DNA’ of the host system.

### SUMMARY

A system and method are provided for generating Unique Digital Signatures (UDS) for computer memories to improve data security. By UDS it is meant a unique, physically unclonable identifier generated at least in part attributing to chip fabrication process variations, which can be used for generating security keys to control access to the memory.

Generally, the method involves allocating a number of native memory cells in a memory device; obtaining a multibit binary entropy string using variations of native threshold voltages (V_{T}) of the allocated cells as an entropy source; and concatenating the binary entropy string with another multibit binary number obtained from a second entropy source internal to the memory device. The result of the concatenation is then mathematically manipulated to generate the UDS.

In one embodiment, a reference voltage is located at a median distribution of V_{T} for the cells, and the entropy string is obtained by reading the cells versus the reference voltage, and assigning those having a V_{T} above the reference voltage a first bit value, and the remaining cells a second bit value.

In another embodiment, obtaining the binary entropy string involves for each memory cell in the number of native memory cells having an address n (memory cell_n) comparing a VT for the memory cell_n to the VT of a second memory cell in the number of native memory cells having an address n+1 (memory cell_n+1) using a comparator in the memory device, and if the VT of memory cell_n is greater than that of memory cell_n+1 assigning memory cell_n a first binary bit value, and if not, assigning a second binary bit value.

The system or memory device to perform the above method includes an array of memory cells having a number of native memory cells allocated as a first entropy source; a microcontroller operable to execute algorithms; and a UDS store in which the UDS is stored for use in generating security keys. Generally the microcontroller is operable to execute algorithms including: obtain a binary entropy string including a first plurality of binary bits using variations in native threshold voltages (VT) for the number of native memory cells; concatenate the binary entropy string with a binary number including a second plurality of binary bits obtained from a second entropy source; and mathematically manipulate a result of the concatenation to generate a UDS for the memory device.

Further features and advantages of embodiments of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS

Embodiments of the invention will now be described, by way of example only, with reference to the accompanying schematic drawings in which corresponding reference symbols indicate corresponding parts. Further, the accompanying drawings, which are incorporated herein and form part of the specification, illustrate embodiments of the present invention, and, together with the description, further serve to explain the principles of the invention and to enable a person skilled in the relevant art(s) to make and use the invention.

FIG. 1A is a block diagram illustrating a sectional side view of one embodiment of a memory cell in a flash or nonvolatile memory (NVM) device;

FIG. 1B is a block diagram illustrating a top view of the memory cell of FIG. 1A;

FIG. 2 is a graph of drain current (Id) to gate-to-source voltage (Vgs) for a number of native memory cells in a portion or block in an array of a memory device illustrating distribution of threshold voltages (V_{T}) at a reference drain current (I₀);

FIG. 3 is a histogram of the mean and sigma threshold voltages (V_{T}) of native memory cells in a portion or block of a memory device illustrating a normal distribution;

FIG. 4 is a flowchart illustrating a method for determining an array voltage (V_{gUDS}) for generating a unique digital signature (UDS);

FIGS. 5A and 5B are graphs of distribution of currents for a number of native memory cells in relation to a reference current, illustrating the method of FIG. 4;

FIG. 6 is a plot of V_{Ts} for a number of native memory cells in a portion or block of a memory device relative to V_{gUDS}, illustrating a method for obtaining a binary entropy string (BES) of a plurality of random binary bits using variations in the V_{Ts} as an entropy source;

FIG. 7 is a plot of V_{T} for a number of native memory cells in a memory device and a comparator illustrating another method for obtaining a BES;

FIG. 8 is a flowchart illustrating a method for generating a unique digital signature (UDS) using a BES obtained using variations in the V_{Ts} for a number of native memory cells in a memory device; and

FIG. 9 is a simplified block diagram of an embedded system including a host system and a secure memory device configured and operable to generate a UDS using variations in native V_{Ts} of a portion or block of the memory device as an entropy source.

### DETAILED DESCRIPTION

A system and methods are provided for generating Unique Digital Signatures (UDS) for semiconductor memories to improve data security and reliability. The system and methods of the present disclosure are particularly useful for flash memories in embedded systems used in autonomous internet or network connected systems and devices, such as cars, smart factories, hospital equipment, and portable medical products.

In the following description, for purposes of explanation, numerous specific details are set forth in order to provide a thorough understanding of the present invention. It will be evident, however, to one skilled in the art that the present invention can be practiced without these specific details. In other instances, well-known structures, and techniques are not shown in detail or are shown in block diagram form in order to avoid unnecessarily obscuring an understanding of this description.

Reference in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment. The term to couple as used herein can include both to directly electrically connect two or more components or elements and to indirectly connect through one or more intervening components.

Briefly, variations in threshold voltages of native memory cells in a memory device arising from processes variations used to fabricate the memory device are translated and used as an entropy source. These variations in threshold voltages are then used to generate a random binary string that is then used to generate a UDS for the memory device. By native it is meant a memory cell that has not been programmed and is unwritten to since fabrication. The variations in threshold voltages can arise from variations in production processes of the memory array that cause minor variations in physical and electrical characteristics of devices in the memory cells including wordline (WL) and bitline (BL) widths, channel lengths, capacitance of a gate oxide or dielectric (C_{OX}), implant uniformity and charging effects.

Generally, the method involves allocating a number of native memory cells in a memory device; obtaining a multibit binary entropy string (BES) using native threshold voltages (V_{T}) distribution of the allocated cells as an entropy source; and mathematically manipulating the BES to generate the UDS. Optionally, the BES can be concatenated with another multibit binary number from a second entropy source internal or external to the memory device, and the result of the concatenation mathematically manipulated to generate the UDS. In one embodiment, a reference is located at a median V_{T} for the cells, and the BES is obtained by reading the cells versus the reference, assigning those having a V_{T} above the reference a first bit value, and the remaining cells a second bit value. In another embodiment, the BES is obtained for each memory cell in the number of native memory cells having an address n (memory cell_n) comparing a V_{T} for the memory cell_n to the V_{T} of a second memory cell in the number of native memory cells having an address n+1 (memory cell_n+1) using a comparator in the memory device, and if the V_{T} of memory cell_n is greater than that of memory cell_n+1 assigning memory cell_n a first binary bit value, and if not, assigning a second binary bit value.

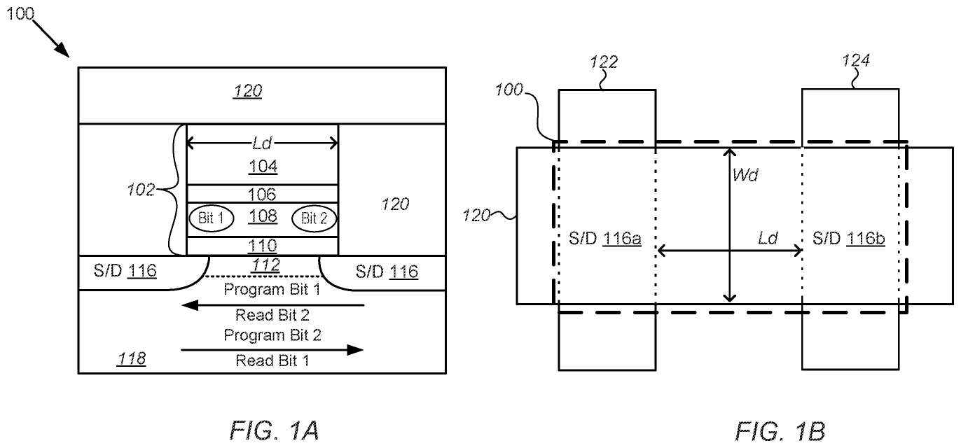

Further details of these and other embodiments of the method and system will now be described in greater detail with reference to FIGS. 1A through 9.

FIG. 1A is a block diagram illustrating a sectional side view of an embodiment of a single memory cell in a flash or nonvolatile memory (NVM) device for which the system and method of the present disclosure is especially useful. FIG. 1B is a block diagram illustrating a sectional side view of the memory cell of FIG. 1A. More specifically, the memory cell illustrated in FIGS. 1A and 1B is a multibit MirrorBit™ memory cell (hereinafter “MirrorBit”, manufactured by Infineon Technologies LLC of San Jose, California), in which the non-conducting nature of a charge-trapping layer allows a single memory transistor to store two spatially separated physical bits of data per cell (2BPC) of the memory device.

Referring to FIG. 1A the memory cell 100 generally includes a charge-trapping gate stack 102 including a control gate 104, an oxide-nitride-oxide or ONO layer made up of a top or blocking dielectric layer 106, a charge-trapping layer 108, and a bottom dielectric layer 110, formed over a channel 112 separating a source and drain regions (S/D 116) in a substrate 118. Through proper biasing the memory cell 100 can store two spatially separated physical bits (bit1 and bit2) as charges at opposite ends of the charge-trapping layer 108. These two independent physical bits (bit1 and bit2) can be independently read by running a current through the channel 112 in different directions as shown.

Referring to FIG. 1B the memory cell 100 further includes a wordline (WL 120) electrically coupled to the control gate 104, and a first bitline (BL₁ 122) electrically coupled to or formed by an implant of a source (S/D 116a), and a second bitline (BL₂ 124) electrically coupled to or formed by an implant of a drain (S/D 116b).

The threshold voltage (V_{T}) is the minimum gate-to-source voltage (V_{GS}) applied between the control gate 104 and source (S/D 116a) needed to create a conducting path between the source and drain (S/D 116b) in the memory cell 100. By native memory cell it is meant a memory cell that has not been programmed or written to since fabrication. Generally, for NVM cells, and specifically in MirrorBit memory cells, the threshold voltage (V_{T}) is taken at a linear region where the gate-to-source voltage is greater than the threshold voltage, and a drain-to-source voltage (Vds) is less than the difference between the gate-to-source voltage and threshold voltage. That is where: Vgs>V_{T} and Vds<Vgs−V_{T}. This ensures that a drain current (Id) of the memory cell 100 will vary linearly with respect to the gate-to-source voltage (Vgs) according to the expression below.

$${I}_{D} = {μ}_{n} {C}_{ox} \frac{W}{L} ( ( {V}_{GS} - {V}_{th} ) {V}_{DS} - \frac{{V}_{DS}^{2}}{2} )$$

where Cₒₓ corresponds to capacitance of the ONO layer, W is memory cell width determined by WL width (WD in FIG. 1), and L is memory cell channel length (channel 112 in FIG. 1A) as determined by BL spacing (LD in FIGS. 1A and 1).

It will be understood that the system and methods described below of using native variations in threshold voltages for memory cells as an entropy source for generation of a UDS, while described in detail with respect to charge-trapping type NVM, and in particular flash-type NVM, can be applied to other types of nonvolatile memories exhibiting a random distribution in threshold voltages, including silicon-oxide-nitride-oxide-silicon (SONOS), metal-oxide-nitride-oxide-silicon (MONOS), split-gate and floating gate (FG) memories. It will further be understood the concepts can be extended to any NVM or non-NVM technologies, such as resistive random access memory (RRAM) technology, that can provide a random distribution having a median can be sensed, that is can provide sufficient current for sensing, and a sigma or variance that is wide enough to enable placing a reference of about a distribution median.

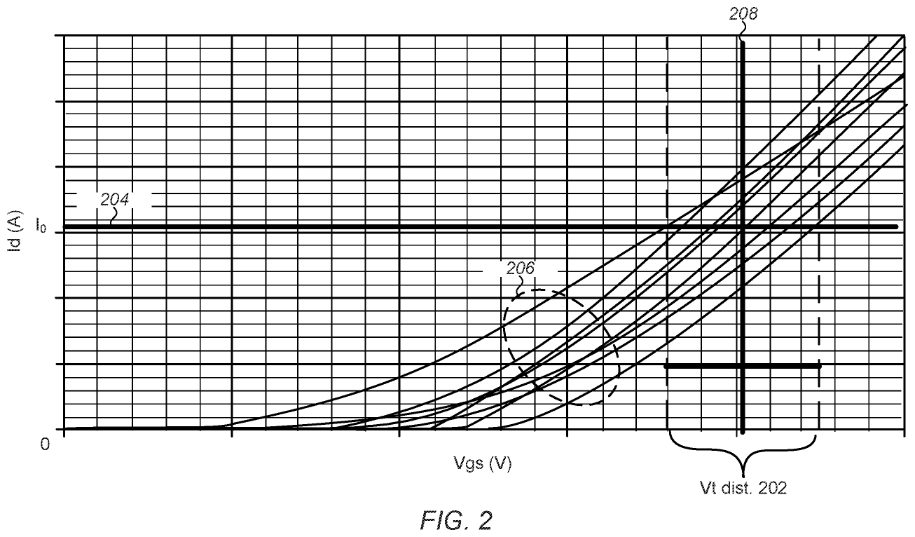

FIG. 2 is a graph of drain current (Id) to gate-to-source voltage (Vgs) for a number of native memory cells in a portion or block of memory cells in an array of a memory device sharing a contiguous address space, and illustrating a distribution of threshold voltages (V_{T} 202) at an average or mean drain current (I₀ 204). Each line 206 represents the Id to Vgs for a single memory cell or bit. It is noted that each memory cell has slightly different slope due to variations in WL and BL widths, channel lengths, C_{OX}, implant uniformity and charging effects, in accordance with the expression given above. It is seen from this figure that each memory cell of such distribution has about a 50% probability to have a native threshold voltage greater than or less than an average or mean native threshold voltage (V₀ 208).

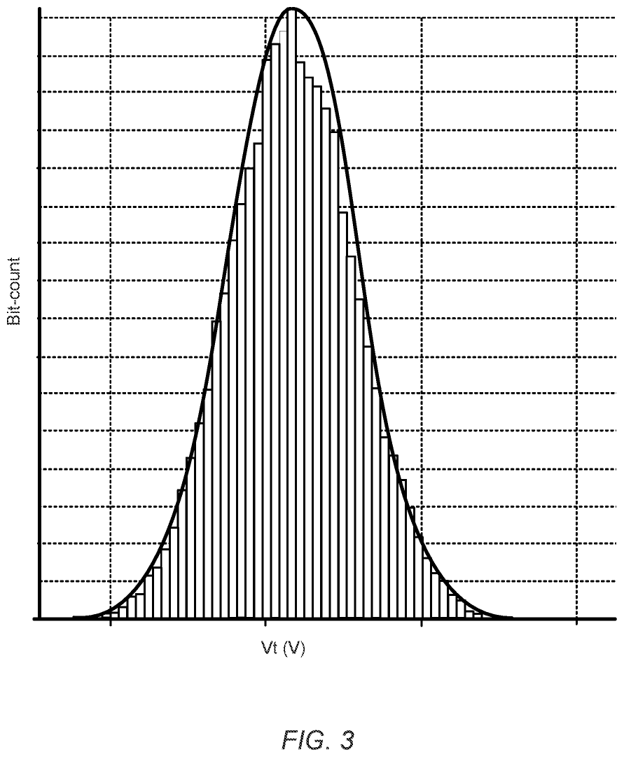

FIG. 3 is a histogram of the mean and sigma of threshold voltages (V_{T}) for a bit-count or number native memory cells in a portion or block of an array illustrating a normal distribution. Referring to FIG. 3, it is noted that the native V_{T} distribution of native memory cells in a memory device is a normal, Gaussian distribution. It is further noted that the average and sigma of native V_{T} distribution is technology and fabrication facility specific and a direct result of the manufacturing process control.

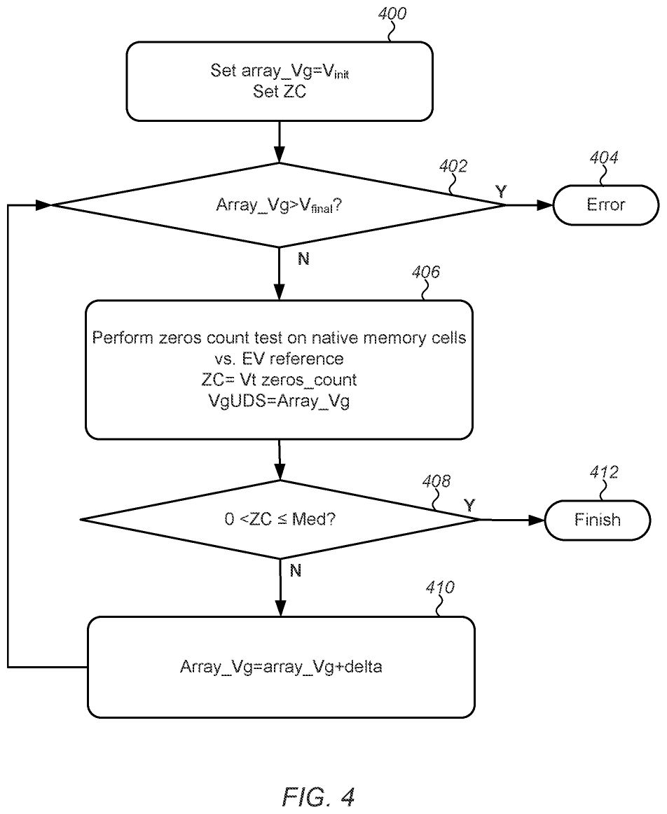

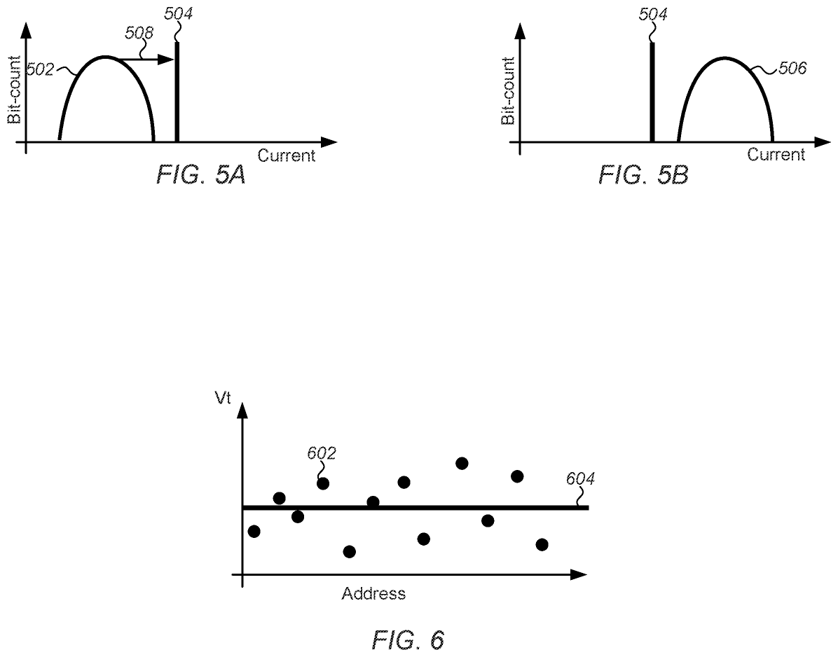

A method for determining a UDS array voltage (V_{gUDS}), so that reference is located at a median of a distribution of threshold voltages (V_{T}) for a number of native memory cells in a portion or block of an array will now be described with reference to the flowchart FIG. 4 and graphs of FIGS. 5A and 5B.

Briefly, a non-volatile memory array is characterized or sensed by applying a fixed voltage on the word lines connecting to the memory/control gates of each row of memory cells; and measuring the output current or drain current of each non-volatile memory cell. The current measurement may be performed by iteratively comparing the output current of each memory cell with an adjustable reference current using a sense amplifier to estimate the output current of the non-volatile memory cells. In some embodiments, these measurements may be made rapidly on a row-by-row basis using the existing sense amplifiers, read bus, and sense amplifier current reference circuitry of the non-volatile memory used during the normal read operation of the memory. The results of the comparison are indicative of the threshold voltage V_{T} and binary state (programmed or erased) of the NVM cells.

FIG. 4 is a flowchart illustrating a method for determining the UDS array voltage (V_{gUDS}). FIGS. 5A and 5B are graphs of distribution of currents for the number of native memory cells in the portion or block (bit-count) when applied with a specific gate voltage (Vg), illustrating a scanning of a gate voltage (Vg) of the array (array_Vg) versus reference to determine the UDS array voltage (V_{gUDS}).

Referring FIG. 4 the method begins with setting a gate voltage for native memory cells in a portion or block of an array of a memory device (array_Vg) equal to a preselected initial voltage (Vᵢₙᵢₜ), and initializing or setting a zero count (ZC) equal to 0 (400). Generally, the Vᵢₙᵢₜ is selected so that a zeros count test performed on the memory cells with a reference voltage will result in a number of zeros greater than a median of a distribution of V_{Ts} for the native memory cells. That is the number of native memory cells having current lower than the reference current and therefore storing a ‘0’ is lower than the reference current. This is illustrated graphically in FIG. 5A which shows the distribution of currents for the native memory cells (distribution_Vᵢₙᵢₜ 502) at an initial gate voltage of Vᵢₙᵢₜ (array_Vg=Vᵢₙᵢₜ), which will produce in all memory cells (bit count) a drain current lower than a reference current 504. The initial gate voltage (Vᵢₙᵢₜ) can be implemented using any voltage available in the memory device and within a range of normal distribution threshold voltages for the memory cells. In the example illustrated in these figures the Vinit selected is an erase verify reference (EV reference), commonly used to verify all cells in the memory device are erased memory.

Next, it is determined if the gate voltage for the array (array_Vg) is greater than a preselected final voltage (V_{final}) (402). Similarly to Vᵢₙᵢₜ, V_{final} is selected so that a test performed at the final voltage (V_{final}) will result in all of the number of native memory cells having current higher than the reference current 504 and therefore storing a ‘1.’ This is illustrated graphically in FIG. 5B which shows the distribution of currents for the native memory cells (distribution_V_{final} 506) at a gate voltage of V_{final} (array_Vg=V_{final}), where all of the native memory cells in the normal distribution have a current higher than the reference current 504.

If the gate voltage for the array (array_Vg) is greater than the final voltage (V_{final}), there has been an error (404) and the method ends.

If the gate voltage currently applied to the array (array_Vg) is not greater than V_{final}, a zeros count test is performed on the number of native memory cells versus the EV reference, the zero count (ZC) is set equal to the number of native memory cells having a current lower than EV reference and therefore storing a ‘0’ (V_{T Zeros_count}), and setting V_{gUDS} equal to array_Vg (406).

Next, it is determined if the updated ZC is greater than zero and less than or equal to a median of the number of native memory cells (408). For example, where the number of native memory cells used for locating the reference voltage (V_{gUDS}) constitutes a 4096 bit block of an array in a memory device the median is 2048. If ZC is greater than zero and less than or equal to the median the array UDS voltage (V_{gUDS}) has been found and the process is finished (412). By defining every memory cell in the memory device having a V_{T} above reference V_{gUDS} as a ‘0’, and the rest as a ‘1’, a binary entropy string (BES) can be obtained having a random of string of binary bits (either ‘0’ or ‘1’) having a length or total number of bits equal to the number of native memory cells in the portion or block of the memory device. This BES can then be used to generate a UDS unique to identify the memory device as detailed below.

If the zeros count (ZC) is not greater than zero and not less than or equal to the median, i.e., the ZC is greater than the median, the gate voltage for the array (array_Vg) is increased by a preselected amount or delta (410), and steps 402 through 408 repeated, turning ‘0s’ into ‘1s’ until V_{gUDS} has been found (step 412) or array_Vg is greater than V_{final} indicating an error has occurred (step 404). This shifting or scanning step is represented graphically by arrow 508 in FIG. 5A. The delta can be any suitable amount voltage selected in relation to Vᵢₙᵢₜ and V_{final} to provide a desired degree of accuracy. For example, where Vᵢₙᵢₜ is selected to be 3.0V and V_{final} to be 5.5V, delta can be selected to be 50 millivolts (mV).

The above described method results in a binary entropy string of binary digits approximately equal to the number of native memory cells, and having random pattern of an approximately equal number of ‘1’s and ‘0’s.

Although the above described method begins a low Vᵢₙᵢₜ which is increased until V_{gUDS} is determined, it will be understood that in another embodiment the method can begin with a high Vᵢₙᵢₜ and scan by decreasing array_Vg by a delta until the zeros count (ZC) is greater than or equal to the median.

Alternatively, the array V_{gUDS} can be found using a binary search technique. That is a gate voltage (array_Vg) selected from within a normal distribution for V_{Ts} of the number of native memory cells can be applied the array, the native memory cells read, and the number of native memory cells having a current lower than the reference current counted—a zero count (ZC). If ZC is less than or equal to a median of the number of native memory cells, array_Vg is increased to a voltage ½ way between the initial array_Vg and a lowest voltage a normal distribution for V_{Ts} and the read and zero count repeated. If ZC is greater than or equal to a median of the number of native memory cells, array_Vg is decreased to a voltage ½ ways between the initial array_Vg and a highest voltage a normal distribution for V_{Ts} and the read and zero count repeated. The process can repeated for a fixed predetermined number of times, or until increments or decrement in the array_Vg are less than predetermined magnitudes. For example 50 mV.

A method for using the UDS voltage (V_{gUDS}) and variations of in V_{Ts} for a number of native memory cells as an entropy source to generate a UDS will now be described with reference to FIG. 6. FIG. 6 is a plot of threshold voltages (V_{Ts} 602) for a number of native memory cells in a portion or block of an array in a memory device, applied with VgUDS, relative to a UDS reference Vt (604). Generally, obtaining the BES involves reading all of the number of native memory cells in the portion or block while applying the V_{gUDS} to the wordlines of the number of native memory cells. Every native memory cell having a V_{T} above reference Vt is defined as storing a ‘0’ bit, and the remaining native memory cells are defined as ‘1’s to create a string of random binary bits, either a ‘0’ or a ‘1’, having a length or number of bits equal to the number of native memory cells in the portion or block of the array. In an alternative embodiment, the assignment of “0” and “1” bit value may be reversed. Thus, where the portion or block includes 4096 native memory cells the BES obtained from reading memory cells likewise includes 4096 bits. Moreover, it is noted that because the V_{Ts} of many of the number of native memory cells are close to reference Vt, and because of charging effects, thermal effects and noise in amplifiers or reading circuits of the memory device, a second BES obtained by reading the same number of native memory cells a second time using the same V_{gUDS} will not be identical to the previously obtained first BES, although it will be closely correlated. Thus, the length and randomness of the BES ensures that a UDS generated from the BES is genuinely unique.

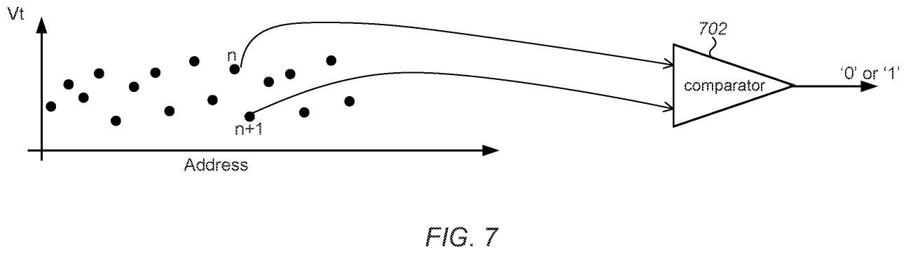

In another embodiment, graphically illustrated in FIG. 7, obtaining a binary entropy string or BES is accomplished by applying an array voltage (array_Vg) to gates of all the number of native memory cells, and comparing a drain current (I_{d}) for each memory cell in the number of native memory cells having an address n (memory cell_n) to the drain current (I_{d}) of a second memory cell in the number of native memory cells having an address n+1 (memory cell_n+1) using a comparator 702 in the memory device. If the drain current (I_{d}) of memory cell_n is less than that of memory cell_n+1, then memory cell_n is determined to have a higher V_{T} that of memory cell_n+1, and is assigned a first binary bit value (‘0’ or ‘1’), and if not, is assigned a second binary bit value. For example, if the V_{T} of memory cell_n is greater than that of memory cell_n+1 then memory cell_n is assigned a ‘0’, and if not it is assigned a ‘1’. The cell address is then indexed to n=n+1, and the process repeated until the last address in the memory portion or block has been reached. It is noted that the V_{T} of each of the number of native memory cells, except the native memory cells with the first and last addresses, is the compared twice so that the BES obtained has a length or number of bits only one less than the number of native memory cells in the portion or block of the array.

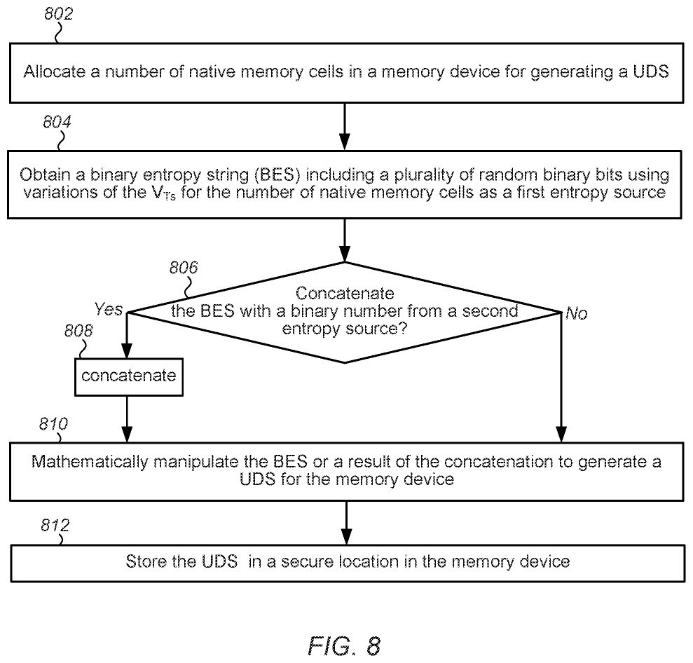

FIG. 8 is a flowchart illustrating a method for generating a unique digital signature (UDS) using variations of V_{T} for a number of native memory cells in a portion or block of an array of a memory device. Referring to FIG. 8, the method begins with allocating a number of native memory cells in the array for generating a UDS (802).

Next, a binary entropy string (BES) including a plurality of random binary bits is obtained using variations of the V_{Ts} for the number of native memory cells as a first entropy source (804). In some embodiments, obtaining the BES involves reading all of the number of native memory cells while applying a UDS reference voltage (V_{gUDS}) to the array. The V_{gUDS} can be determined either by the method described with respect to FIG. 4, or by a binary search as described above. Every native memory cell having a V_{T} above V_{gUDS} is defined as a ‘0’ bit, and the remaining native memory cells are defined as ‘1’s to create a string of random binary bits, either a ‘0’ or a ‘1’, having a length or number of bits equal to the number of native memory cells in the portion or block of the array.

Alternatively, the BES can be created directly from the number of native memory cells without the need for determining V_{gUDS} using the method described above with respect to FIG. 6. Briefly, the method includes applying an array voltage (Vg) to gates of all of the number of native memory cells, and comparing a resultant drain current from each of the number of native memory cells to the drain current of the native memory cell in a next address. If the drain current of the first memory cell (memory cell_n) is less than that of the second memory cell (memory cell_n+1), it is determined that the V_{T} for memory cell_n is greater than the V_{T} of memory cell_n+1, and memory cell_n is defined as having a binary bit value ‘0’, and if not a binary bit value ‘1’.

In some embodiments an additional or second, independent entropy source can be used to improve randomness or to comply with an existing customer or industry standard (806). The second entropy source can include an entropy source in the memory device itself, such as a True Random Number Generator (TRNG) implemented using a timer or clock in the memory device and executing a TRNG algorithm.

If a second entropy source is used the BES is concatenated with another binary number including a second plurality of random, binary bits obtained from the second entropy source (808).

Next, the BES, or the result of the concatenation where a second entropy source is used, is mathematically manipulated to generate a UDS for the memory device (810). In some embodiments, mathematically manipulating the BES or the result of the concatenation can be accomplished using a Hash-based Message Authentication Code (HMAC) technique.

Finally, the UDS is stored in a secure location in the memory device (812), and is then used to generate security keys for accessing the memory device. Optionally, the stored UDS can be used for other security features.

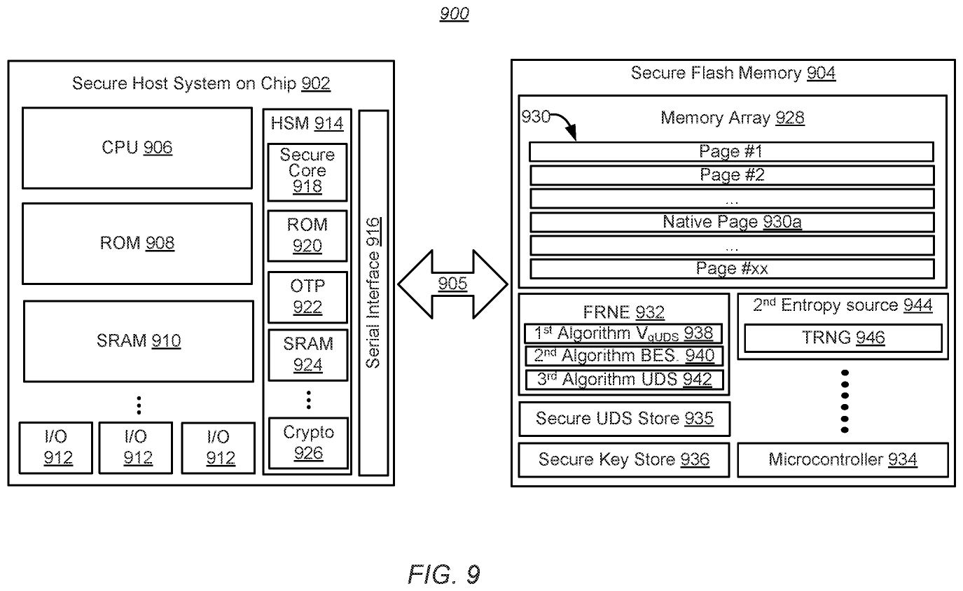

An embedded system including a host system and a secure NVM configured and operable to obtain a binary entropy string using variations of native V_{T} for a number of native memory cells in as an entropy source to generate a UDS will now be described with reference to FIG. 9.

Referring to FIG. 9 the embedded system 900 includes a host system 902 and a secure NVM 904 coupled through a data bus 905. The host system 902 generally includes a central processing unit (CPU 906), read only memory (ROM 908) storing programs and algorithms, random access memory (RAM 910), a number of input/output interfaces (I/O 912), an optional hardware security module (HSM 914) and a serial peripheral interface (SPI 916) through which the host system communicates with the secure NVM 904. The host system 902 can be integrally formed as a single integrated circuit (IC) or System on Chip (SoC), as in the embodiment shown, or as a number of interconnected discrete components. The HSM 914) generally includes a secure core 918 for executing programs and algorithms relating to secure communication with the secure NVM 904, a read only memory (ROM 920) storing such programs and algorithms, a one-time-password module (OTP 922) for storing and verifying a OTP, random access memory (RAM 924), and a crypto module or engine (Crypto 926).

The secure NVM 904 generally includes a memory array 928 having a number of portions or blocks 930 of memory cells, at least one of which is a native block 930a, in which the memory cells included therein have not been written to since fabrication, reserved or allocated for generating a binary entropy string and UDS according to one of the above described methods. The secure NVM 904 further includes a flash random number extraction (FRNE 932) having stored in registers or memories therein programs or algorithms for generating the UDS, a microcontroller 934 for executing the programs or algorithms for generating the UDS and for generating security keys from the UDS, a UDS store 935 in the secure NVM 904 for storing the UDS, and, optionally, a secure key store 936 for storing the security keys used to control access to the memory device.

Generally, the FRNE 932 can include a first memory or register 938 having stored therein an algorithm for locating a reference voltage (V_{gUDS}) at a median of threshold voltages (V_{T}) of memory cell in the native block 930a, a 2^{nd} memory or register 940 having stored therein an algorithm for obtaining a binary entropy string (BES) using variations of native threshold voltages of memory cells in the native block, and a 3^{rd} memory or register 942 having stored therein an algorithm for generating the UDS using the BES. In one embodiment, the algorithm for obtaining the BES includes instructions for reading the number of native memory cells versus the reference voltage, and assigning each of the number of native memory cells having a threshold voltages above the reference voltage a first binary bit value, ‘0’, and each of the remaining memory cells as a second binary bit value, ‘1’.

Alternatively, the algorithm for obtaining the BES includes instructions for comparing a V_{T} for each in the number of native memory cells having an address n (memory cell_n) to the V_{T} of a second memory cell (memory cell_n+1) using a comparator in the microcontroller 934 or FRNE, and assigning each memory cell_n a first or second binary bit value.

In some embodiment, such as that shown, the secure NVM 904 further includes a second entropy source 944, such as a True Random Number Generator (TRNG 946) implemented using a timer or clock in the secure NVM and a TRNG algorithm stored in the TRNG, for generating a second binary number that is concatenated with BES and mathematically manipulated by the microcontroller 934 to generate the UDS. As noted above, the result of the concatenation can be mathematically manipulated by the microcontroller 934 using a Hash-based Message Authentication Code (HMAC) technique.

It will be understood that the above described methods of using native variations in threshold voltages for memory cells as an entropy source for generation of a UDS while described in detail with respect to flash type memory devices, can be applied or extended to other types of semiconductor memories exhibiting a random distribution in threshold voltages, even when not due to process variations in native memory cells.

Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method comprising:
allocating a number of native memory cells in a memory device;
obtaining a binary entropy string comprising a first plurality of binary bits using variations of threshold voltages (V_{T}) of the number of native memory cells as a first entropy source; and
mathematically manipulating the binary entropy string to generate a Unique Digital Signature (UDS) for the memory device.

2. The method of claim 1 obtaining a binary entropy string comprises:
determining a UDS array voltage (V_{gUDS}) located at a median for a distribution of V_{T} for the number of native memory cells;
determining for each of the number of native memory cells whether it has a V_{T} above the V_{gUDS}; and
assigning each of the number of native memory cells having a V_{T} above the V_{gUDS}a first binary bit value, and each of the remaining number of native memory cells a second binary bit value.

3. The method of claim 2 wherein determining the V_{gUDS} comprises:
applying to gates of the number of native memory cells an array voltage (Vg), Vg equal to an initial voltage (Vᵢₙᵢₜ) selected to produce in all of the number of native memory cells drain currents (Ia) lower than a reference current (I₀);
increasing the array voltage (Vg) by a predetermined voltage (delta) and reading each of the number of native memory cells at an incremented array voltage (Vg+delta) by comparing a resulting drain current to the reference current (I₀);
repeating increasing the array voltage (Vg) and reading each of the number of native memory cells until the incremented array voltage (Vg+delta) results in half of the number of native memory cells having drain currents (Ia) higher than the reference current (I₀); and
setting the V_{gUDS} equal to last incremented array voltage (Vg+delta).

4. The method of claim 3 wherein determining for each of the number of native memory cells whether it has a V_{T} above the V_{gUDS} comprises:
applying to gates of the number of native memory cells an array voltage (Vg) equal to the V_{gUDS};
reading the number of native memory cells with the V_{gUDS} applied to gates thereof by comparing the drain current of each of the number of native memory cells to the reference current (I₀); and
identifying each of the number of native memory cells having drain currents less than the reference current (I₀) as having a V_{T} above the V_{gUDS}.

5. The method of claim 2 wherein the first binary bit value is ‘0’ and the second binary bit value is ‘1’, and wherein obtaining the binary entropy string results in a string of binary digits approximately equal to the number of native memory cells, and having random pattern of an approximately equal number of ‘1’s and ‘0’s.

6. The method of claim 1 wherein obtaining the binary entropy string comprises:
for each memory cell in the number of native memory cells having an address n (memory cell_n), comparing a V_{T} for the memory cell_n to a V_{T} of a second memory cell in the number of native memory cells having an address n+1 (memory cell_n+1) using a comparator in the memory device, and if the V_{T} of memory cell_n is greater than the V_{T} of memory cell_n+1 defining memory cell_n as having a binary bit value ‘0’, and if not a binary bit value ‘1’.

7. The method of claim 6 wherein comparing a V_{T} for the memory cell_n to a V_{T} of a second memory cell in the number of native memory cells having an address n+1 comprises:
applying to gates of both memory cell_n and memory cell_n+1 an array voltage (Vg);
comparing a first drain current from memory cell_n to a second drain current from memory cell_n+1; and
if the first drain current is less than the second drain current determining the V_{T} for the memory cell_n is greater than the V_{T} of memory cell_n+1, and defining memory cell_n as having a binary bit value ‘0’, and if not a binary bit value ‘1’.

8. The method of claim 1 further comprising concatenating the binary entropy string with a binary number comprising a second plurality of binary bits obtained from a second entropy source, and wherein mathematically manipulating the binary entropy string to generate the UDS comprises mathematically manipulating a result of the concatenation to generate the UDS.

9. The method of claim 8 wherein mathematically manipulating the result of the concatenation comprises mathematically manipulating the result of the concatenation using a Hash-based Message Authentication Code (HMAC) technique to generate the UDS.

10. The method of claim 8 wherein a number of bits in the first plurality of binary bits is greater than a number of bits in the second plurality of binary bits.

11. The method of claim 8 wherein the second entropy source comprises a True Random Number Generator (TRNG) in the memory device.

12. The method of claim 1 wherein the number of native memory cells comprise a contiguous block of address space in the memory device.

13. The method of claim 1 wherein the memory device is a non-volatile memory device.

14. A memory device comprising:
an array of memory cells including a number of native memory cells allocated as a first entropy source; and
a microcontroller operable to execute algorithms to:
obtain a binary entropy string comprising a first plurality of binary bits using variations of threshold voltages (V_{T}) for the number of native memory cells; and
mathematically manipulate a result of the binary entropy string to generate a unique digital signature (UDS) for the memory device.

15. The memory device of claim 14 wherein the algorithm to obtain the binary entropy string comprises steps including reading the number of native memory cells applied with UDS voltage (V_{gUDS}) versus a reference current (1o), and assigning each of the number of native memory cells having a resultant drain current (I_{d}) less than I₀ as having a V_{T} above the V_{gUDS} and assigning the memory cell a first binary bit value, and each of the remaining number of native memory cells a second binary bit value.

16. The memory device of claim 14 further comprising a comparator in the memory device, and wherein the algorithm to obtain the binary entropy string comprises steps including:
applying to gates of the number of native memory cells an array voltage (Vg);
for each memory cell in the number of native memory cells having an address n (memory cell_n) comparing using the comparator a first drain current from a second memory cell in the number of native memory cells having an address n+1 (memory cell_n+1); and
if the first drain current is less than the second drain current determining the V_{T} for the memory cell_n is greater than the V_{T} of memory cell_n+1, and defining memory cell_n as having a binary bit value ‘0’, and if not a binary bit value ‘1’.

17. The memory device of claim 14 further comprising a second entropy source in the memory device, wherein the microcontroller is further operable to execute an algorithm operable to concatenate the binary entropy string with a binary number comprising a second plurality of binary bits obtained from the second entropy source, and wherein the algorithm to mathematically manipulate the binary entropy string is operable to mathematically manipulate a result of the concatenation to generate the UDS.

18. The memory device of claim 17 wherein the second entropy source comprises a True Random Number Generator (TRNG) in the memory device.

19. A method comprising:
allocating a number of memory cells in a memory device having a normal distribution of threshold voltages (V_{T});
obtaining a binary entropy string comprising a plurality of binary bits using variations of the V_{T}s of the number of memory cells as an entropy source; and
mathematically manipulating the binary entropy string to generate a Unique Digital Signature (UDS) for the memory device.

20. The method of claim 19 further comprising determining a reference voltage at a median of the normal distribution of V_{Ts} for the number of memory cells, and wherein obtaining the binary entropy string comprises reading the number of memory cells versus the reference voltage, and assigning each of the number of memory cells having a V_{T} above the reference voltage a first binary bit value, and each of the remaining number of memory cells a second binary bit value.
